(19) United States
(12) Patent Application Publication
(10) Pub. No.: US 2016/0103452 A1
(43) Pub. Date: Apr. 14, 2016

(54) SYSTEM AND METHOD FOR MANAGING WATER IN WATER PIPE NETWORK

(71) Applicant: LSIS CO., LTD., Anyang-si (KR)

(72) Inventor: MIN GU KANG, Seoul (KR)

(73) Assignee: LSIS CO., LTD., Anyang-si (KR)

(21) Appl. No.: 14/866,708

(22) Filed: Sep. 25, 2015

(30) Foreign Application Priority Data
Oct. 14, 2014 (KR) 10-2014-0138559

(51) Int. Cl. G05D 7/06; G05B 15/02

(52) U.S. Cl. CPC G05D 7/0635; G05B 15/02

(57) ABSTRACT

A system for managing water in a water pipe network is disclosed. The system draws an optimal pump operation schedule and a result of hydraulic analysis, by performing an integrated simulation of hydraulic analysis and optimization based on the hydraulic analysis data for optimization calculation and demand amount data generated using an optimization setting parameter and history data.

### CROSS-REFERENCE TO RELATED APPLICATION

Pursuant to 35 U.S.C. §119(a), this application claims the benefit of earlier filing date and right of priority to Korean Patent Application No(s). 10-2014-0138559, filed on Oct. 14, 2014, the contents of which are all hereby incorporated by reference herein in its entirety.

### BACKGROUND

1. Field of the Disclosure

The present disclosure relates to a system and a method for managing water in a water pipe network.

2. Discussion of the Related Art

The multi-regional water supply system of Korea has a complex water supply system where a multiple systems are constructed by steps, and each system is operated in linkage via emergency connection pipelines. Regarding optimal operation of the multi-regional water supply system, the following document is disclosed.

[Document 1] Korean Patent Publication No.10-2006-0125292 (Dec. 6, 2006)

However, there has been a problem in that the technology disclosed in the above document may be applied only to some particular water operation sites, and different water operation application software that has been individually developed is difficult to be integrated with each other. In addition, there has been still another problem that the user convenience is lowered because the operation application software is developed as dedicated application software separate from the SCADA (Supervisory Control And Data Acquisition) platform.

### SUMMARY OF THE DISCLOSURE

One of purposes that the present disclosure intends to achieve is, to provide a system for managing water in a water pipe network, wherein the system may provide an operation method of pumps and valves, which may stably supply water as well as minimize energy consumption.

In a general aspect of the present disclosure, there is provided a system for managing water in a water pipe network, the system comprising: a hydraulic analysis unit configured to output hydraulic analysis data with respect to links and nodes forming a pipeline network by performing a hydraulic analysis simulation using initial pipeline network hydraulic analysis data; a calibration unit configured to determine an optimal roughness coefficient by comparing a result of hydraulic analysis simulation using roughness coefficient data and demand amount data of a predetermined pipeline to error information based on an actual performance, and to generate hydraulic analysis data for optimization calculation by applying the optimal roughness coefficient; an optimization unit configured to draw an optimal pump operation schedule and a result of hydraulic analysis by performing an integrated simulation of hydraulic analysis and optimization based on the hydraulic analysis data for optimization calculation and demand amount data generated using an optimization setting parameter and history data, and to provide input data from which the optimal pump operation schedule and the result of hydraulic analysis are drawn as a parameter for optimization; and an operator terminal including a real-time operating unit configured to draw the optimal pump operation schedule and the result of hydraulic analysis by performing an integrated simulation of hydraulic analysis and optimization based on demand amount data generated using the parameter for optimization.

In some exemplary embodiments of the present disclosure, the initial pipeline network hydraulic analysis data may include pipeline network facility data and pipeline network simulation condition data.

In some exemplary embodiments of the present disclosure, the pipeline network simulation condition data may include at least one of pattern, energy, curve, option and time.

In some exemplary embodiments of the present disclosure, the pipeline network simulation condition data may include at least one of pattern, energy, curve, option and time.

In some exemplary embodiments of the present disclosure, the calibration unit may perform a hydraulic analysis simulation of roughness coefficient of the predetermined pipeline according to a plurality of cases.

In some exemplary embodiments of the present disclosure, the calibration unit may select a flow amount tag during a certain period of history data, and may calculate demand amount data from the flow amount data.

In some exemplary embodiments of the present disclosure, the optimization unit may further draw a result of demand forecasting linked to a result of the optimal pump operation schedule.

In some exemplary embodiments of the present disclosure, the optimization unit may further draw hydraulic analysis with respect to a link and a node corresponding to the optimal pump operation schedule.

In some exemplary embodiments of the present disclosure, the optimization unit may draw hydraulic analysis data with respect to a link and a node in chronological order, may draw hydraulic analysis data with respect to a link and a node in an order of pipeline networks, or may draw hydraulic data with respect to a link and a node in a relevant network at a predetermined time.

In some exemplary embodiments of the present disclosure, the optimization unit may refer to a user predetermined value as water level in tank and demand pattern.

In another general aspect of the present disclosure, there is provided an operation method of an operating server for managing a water pipe network by receiving data from the operator terminal of the system for managing a water pipe network, the operation method comprising: receiving hydraulic analysis data with respect to links and nodes forming a pipeline network, hydraulic analysis data for optimization calculation, and data including system boundary setting value inputted by a user; searching an optimal solution with respect to control variables (pumps and valves) through an optimization algorithm calculation linked to hydraulic analysis; and drawing an optimal control value of a decision variable determined at a current time slot.

In some exemplary embodiments of the present disclosure, the system boundary setting value may be received via a SCADA (Supervisory Control and Data Acquisition) unit.

In some exemplary embodiments of the present disclosure, the data may further include demand amount data by demand breakpoints.

In some exemplary embodiments of the present disclosure, the data may further include an electricity rate system set by a user.

In some exemplary embodiments of the present disclosure, the operation method may further comprise: outputting result data with respect to links and nodes forming a pipeline network by performing a hydraulic analysis simulation corresponding to the optimal control value.

In some exemplary embodiments of the present disclosure, result data with respect to links and nodes according to the decision variable determined at a current time slot may be used as hydraulic analysis data with respect to links and nodes composing a pipeline network in the step of receiving at a next time slot.

According to an exemplary embodiment of the present disclosure, the program may be integrated through data sharing and function coupling between each application at the operator terminal and the operating server, by packaging the operating system based on hydraulic analysis and optimization algorithm. In addition, each of the applications may function independently on each other to improve expertise and efficiency of operation such as hydraulic analysis of a pipeline network and pump operating simulation, and a display may be provided for a user through the SCADA unit to enhance user convenience.

In addition, the system according to an exemplary embodiment of the present disclosure may be linked to another system, through development of application in a unit of module.

In addition, according to an exemplary embodiment of the present disclosure, various operational constraint conditions may be reflected, and the accuracy may be enhanced by linking hydraulic analysis to optimization.

### BRIEF DESCRIPTION OF THE DRAWINGS

FIG. 1 is a block diagram schematically illustrating a system for managing water in a water pipe network according to an exemplary embodiment of the present disclosure.

FIG. 2 is a detailed exemplary embodiment block diagram of an operator terminal illustrated in FIG. 1.

FIG. 3 is a detailed exemplary embodiment block diagram of an operating server illustrated in FIG. 1.

FIG. 4 is a detailed exemplary embodiment block diagram of a DB server illustrated in FIG. 1.

FIG. 5 is an exemplary view describing operation of an operating system according to an exemplary embodiment of the present disclosure.

FIG. 6 is an exemplary view describing operation of the present disclosure.

FIG. 7 is an exemplary view describing operation method of a real-time operating unit of the operator terminal.

### DETAILED DESCRIPTION

Various exemplary embodiments will be described more fully hereinafter with reference to the accompanying drawings, in which some exemplary embodiments are shown. The present inventive concept may, however, be embodied in many different forms and should not be construed as limited to the exemplary embodiments set forth herein. Rather, the described aspect is intended to embrace all such alterations, modifications, variations, and equivalents that fall within the scope and novel idea of the present disclosure.

Recently, according to the energy target management system of the Korean government, KEPCO (Korea Electric Power Corporation) adopts a ‘peak time rates’, so as to apply the highest rate during the peak demand hours when the electricity is mostly consumed at the most in a day, apply the rate at average cost level when the electricity is consumed at average level, and to apply the lowest rate during the light load hours when the electricity is consumed at the least in a day. In addition, in order to rationalize use of resources by the demand side management, the higher rate is charged during summer when the energy consumption reaches a peak in a year, and in the same sense, the higher rate is charged during hours when demand for electricity is concentrated in a day. One of purposes of the present disclosure is to establish an operation plan to avoid water operation during such hours when demand for electricity is concentrated, as long as possible.

The operation of water pipe network is a high energy consuming work. Booster stations are installed and operated at almost every supply point, in order to stably supply quality water to consumers. In addition, reducing valves and flow control valves are installed all over the system and operated to control water pressure in the system to be maintained at an optimal level, or to control flow direction of water. Therefore, according to an exemplary embodiment of the present disclosure, the pump and valve facilities may be controlled in real time, and thereby the system may be operated optimally and enormous amount of energy may be conserved.

In general, the booster stations are operated by manualizing ON/OFF status of pumps by time slots based on operation performance in the past and experience of the system operator, or by determining whether to actuate the pumps according to water level of a distributing reservoir or a water tank using a monitoring system in the water management system.

However, such operation method takes stability and supply capacity of the system as a top priority so as to cause excess hydrostatic pressure or to maintain water level in the tank higher than required, and thus is not preferable in an aspect of energy efficiency. In a case when the pump is driven beyond the rated operational point in order to maintain water level of the distributing reservoir above an optimal water level, rational use of energy may not be sought, and lifespan of the pump may be shortened or the system may be overloaded due to frequent driving of the pump. In addition, the operational water level range (difference between the maximum acceptable water level and the minimum acceptable water level) is not wide, so that concern of water quality degradation may be caused.

Therefore, in order to operate the pumps efficiently, water amount used after a certain time is required to be estimated beforehand, and the pressurized flow and pump-up head in response to the estimated water amount used is also required to be figured out. Thereby, the pumps having optimal capacity should be selected and operated, so that waste of energy can be prevented and effective management of the pumps may be enabled. In addition, concerns of water degradation may be reduced by operating the distributing reservoir in a wide range through such process.

In the case of Korea, although the detailed circumstances are different by regions, there are many mountain areas and the change in altitude is wide, thus it is difficult to maintain a stable water pressure throughout the system. Therefore, most of the structures of water supply systems preferably take non-pressure water supply, by installing the distributing reservoirs in the highlands. That is, the booster station is arranged at an end portion of the purification plant so as to supply the purified water to the distributing reservoir in the highland.

Afterwards, the water is supplied from the distributing reservoir to consumers by non-pressure flow.

An ideal operation of the pump station is to reserve water in the distributing reservoir or the gravity tank during hours when the electricity unit cost is inexpensive, and to stop the pump operation and supply the water reserved in the retention facility.

Therefore, according to an exemplary embodiment of the present disclosure, the optimal operation of water pipe network is to find an operation method of pumps and valves for stably supplying water as well as minimizing energy consumption. Such optimal operation may enable real-time response to change in demand amount for a ‘short term’, and may retrench operational cost of the system for a ‘long term’.

Additionally, lifespan of the pumps may be extended and overload of the system may be prevented through the optimal operation of pumps, and water quality improvement may be sought through efficient water level control of the retention facility. In general, operational cost occupies most of the total cost of pump facility, compared to purchasing cost and maintenance expenditure of the pumps. Therefore, the pipeline system using high-capacity pumps is required to continuously monitor performance of the pumps so as to optimize operation and retrench energy consumption.

According to an exemplary embodiment of the present disclosure, an optimal schedule for operating pumps/valves during a given period may be planned in real time, by hydraulic analysis of the water pipe network system and water demand forecasting.

Hereinafter, referring to enclosed drawings, an exemplary embodiment of the present disclosure will be described in detail.

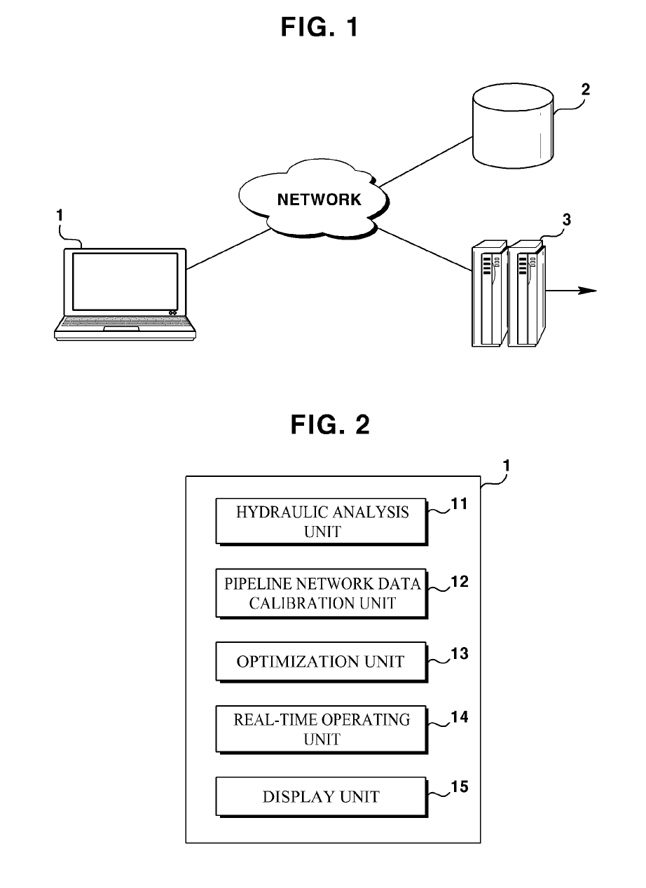

FIG. 1 is a block diagram schematically illustrating a system for managing water in a water pipe network according to an exemplary embodiment of the present disclosure.

As illustrated in FIG. 1, the system according to an exemplary embodiment of the present disclosure may include an operator terminal (1), a DB (Database) server (2) and an operating server (3). The operator terminal (1), the DB (Database) server (2) and the operating server (3) may be connected through a network. Here, the network may be a dedicated network for managing the water pipe network. Otherwise, a public network such as an electric power line communication may be used.

The operating server (3) may be also connected to a multi-regional water supply.

FIG. 2 is a detailed exemplary embodiment block diagram of an operator terminal (1) illustrated in FIG. 1. As illustrated in FIG. 2, the operator terminal (1) according to an exemplary embodiment of the present application may include a hydraulic analysis unit (11), a pipeline network data calibration unit (12), an optimization unit (13), a real-time operating unit(14), and a display unit (15). The operator terminal (1) may be, for example, an HMI (Human-Machine Interface) device. In addition, although an example of a structure where the operator terminal (1) is formed as a single HMI device, each of the hydraulic analysis unit (11), the pipeline network data calibration unit (12), the optimization unit (13), a real-time operating unit(14), and the display unit (15) may be respectively formed a separate HMI device. Otherwise, each component of the operator terminal (1) may be implemented as the relevant application in a single operator terminal (1).

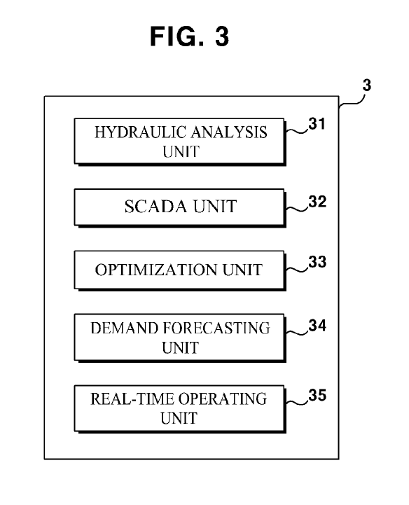

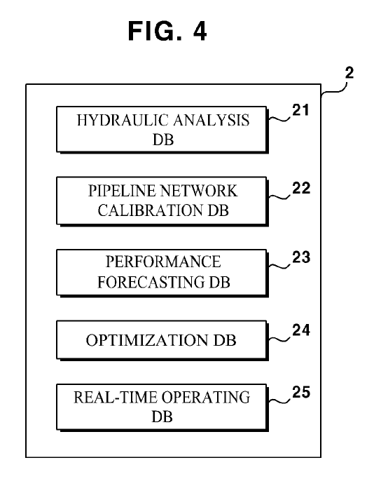

In addition, FIG. 3 is a detailed exemplary embodiment block diagram of an operating server (3) illustrated in FIG. 1, and FIG. 4 is a detailed exemplary embodiment block diagram of a DB server (2) illustrated in FIG. 1. As illustrated in FIG. 3, the operating server (3) may include a hydraulic analysis unit (31), a SCADA (Supervisory Control and Data Acquisition) unit (32), an optimization unit (33), a demand forecasting unit (34) and a real-time operating unit (35). The DB server (2) may include a hydraulic analysis DB (21), a pipeline network calibration DB (22), a performance forecasting DB (23), an optimization DB (24) and a real-time operating DB(25).

Operations of the operator terminal (1), the DB server (2) and the operating server (3) may be linked to one another. Hereinafter, functions and operations of each component will be described.

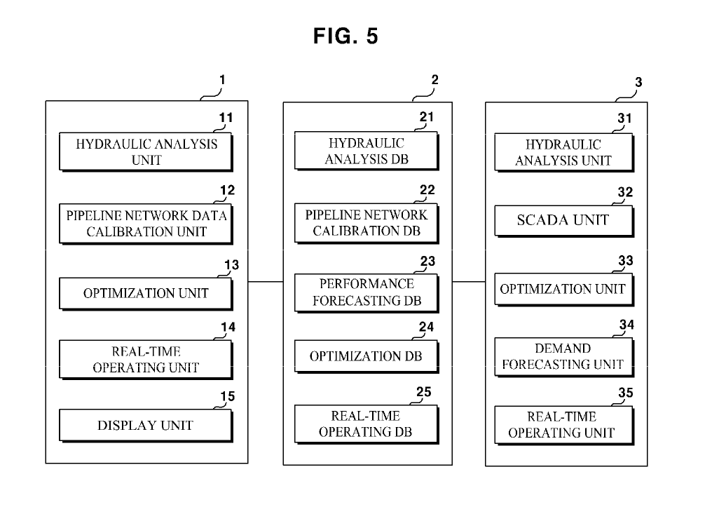

FIG. 5 is an exemplary view describing operation of an operating system according to an exemplary embodiment of the present disclosure.

The hydraulic analysis unit (11) of the operator terminal (1) may edit a pipeline network facility table of a hydraulic analysis DB(21), and may edit a table corresponding to a pipeline network simulation condition. Here, the pipeline network facility table may include a junction, a tank, a pipe, a valve and a pump. The table corresponding to the pipeline network simulation condition may include pattern, energy, curve, option and time. The edited data may be stored in the hydraulic analysis DB (21).

In addition, the hydraulic analysis unit (11) may perform a hydraulic analysis using the edited data. Here, a predetermined engine may be used for the hydraulic analysis. For example, a water distribution system modeling software package, ‘EPANET’ may be used.

In addition, the hydraulic analysis unit (11) may analyze a result of the performed hydraulic analysis. The result may include a simulation result with respect to links and nodes forming the pipeline network. Here, the hydraulic analysis unit(11) may analyze the simulation result with respect to links and nodes in chronological order, may analyze the simulation result with respect to links and nodes in an order of pipeline networks, or may analyze the simulation result with respect to links and nodes in a relevant network at a predetermined time. Here, the link may include flow, velocity, headloss and status, and the node may include demand, pressure and head. This analysis result may be provided for the operator through the display unit (15).

Meanwhile, the hydraulic analysis unit (31) of the operating server (3) may perform a hydraulic analysis with respect to links and nodes by receiving data stored in the hydraulic analysis DB (21), and may provide a result of the hydraulic analysis to the hydraulic analysis DB (21). Here, in the same manner as in the above, the EPANET may be used for the hydraulic analysis.

The operator may ascertain the result analyzed by the hydraulic analysis unit (31) through the display unit (15) of the operator terminal (1).

The pipeline network data calibration unit (12) of the operator terminal (1) may select a particular period by inquiry of history data in the performance forecasting DB (23), and may convert flow amount data to demand amount data, by selecting a particular flow amount tag during the relevant particular period. In addition, the operator may input a roughness coefficient of a pipeline, and may store the inputted roughness coefficient in the pipeline calibration DB (22).

Here, the history data may be updated in the performance forecasting DB (23) by real-time data output of the SCADA unit (32).

In addition, the pipeline network data calibration unit (12) may perform a hydraulic analysis simulation of roughness coefficient of a particular pipeline according to various cases, and may perform a reciprocal comparative analysis by calculating error with respect to actual flow amount and pressure of pipelines from the result of the hydraulic analysis simulation.

In addition, the pipeline network data calibration unit (12) may calibrate for an optimal roughness coefficient. The pipeline network data calibration unit (12) may update the roughness coefficient stored in the pipeline network calibration DB (22) to the optimal roughness coefficient through a process to find minimum error between an estimated value and an actual value of the roughness coefficient of the pipeline.

The optimization unit (13) of the operator terminal (1) may select a particular period by inquiry of history data in the performance forecasting DB (23), and may convert flow amount data to demand amount data, by selecting a particular flow amount tag during the particular period. In addition, the optimization unit (13) may set a parameter of optimization algorithm, and may edit an initial condition (electricity rate table, pump performance curve), a boundary condition (operational water level in tank) and a constraint condition (current water level in tank, ON/OFF times of the pump in history) of the simulation and store the edited conditions.

In addition, the optimization unit (13) may perform an optimization algorithm simulation based on history data in order to establish an operation plan of pumps/valves, and display the simulation result on the display unit (15). In addition, the optimization unit (13) may establish an operation plan of pumps, using the edited algorithm parameter.

Hereupon, the optimal combination schedule for pump operation may be drawn, electricity unit rate and electricity cost may be drawn, and the result of demand forecasting linked to the result of pump operation schedule may be inquired. The drawn results may be displayed via the display unit (15), and may be stored in the optimization DB (24).

Meanwhile, the optimization unit (33) of the operating server (3) may perform an optimization algorithm by receiving hydraulic analysis input data from the hydraulic analysis Db (21) and receiving an algorithm parameter from the optimization DB (24). Whereupon, the optimal combination schedule for pump operation, the electricity unit rate and cost, and the result of hydraulic analysis with respect to links and nodes may be drawn.

The optimization unit (13) may store the input data that generated the drawn optimal pump operation schedule and result of hydraulic analysis in the optimization DB (24), and provide the input data to the real-time operating unit (14) as an optimization parameter.

The real-time operating unit (14) of the operator terminal (1) may receive hydraulic analysis input data from the hydraulic analysis DB (21), receive an algorithm parameter from the optimization DB (24), and may select a particular period through inquiry of history data. In addition, the real-time operating unit (14) may map a particular tag in order to automatically calculate the demand amount, using history data during the particular period.

In addition, the real-time operating unit (14) may set a parameter of the real-time operating unit (35) of the operating server (3), and may store the parameter in the real-time operating DB (25). In addition, the real-time operating unit (14) may edit an initial condition (electricity rate table, pump performance curve), a boundary condition (operational water level in tank) and a constraint condition (current water level in tank, ON/OFF times of the pump in history) of the simulation and store the edited conditions in the real-time operating DB (25). In addition, the real-time operating unit (14) may perform the optimization algorithm for real-time pump operation in real-time. That is, the real-time operating unit (14) may perform the optimization algorithm using the optimization parameter drawn by the optimization unit (13), provide the result of the optimization algorithm via the display unit (15), and may establish a pump operation schedule.

Whereupon, the optimal combination schedule for pump operation may be drawn, electricity unit rate and electricity cost may be drawn, and the result of demand forecasting linked to the result of pump operation schedule may be inquired. The drawn results may be displayed via the display unit (15), and may be stored in the real-time operating DB (25). In addition, the real-time operating unit (35) of the operating server (3) may be driven, based on the outputted data.

In addition, the real-time operating unit (14) may define workplaces by pump stations, booster stations, branches and distributing reservoirs. The real-time operating unit (14) may set tag information with respect to inflow amount, outflow amount, water level, pumps and valves for each of the workplaces, and may provide operation result of the inflow amount, outflow amount, water level, pumps and valves for each of the workplaces via the display unit (15).

Meanwhile, the real-time operating unit (35) of the operating server (3) may receive the parameter set by the real-time operating unit (14), refer to hydraulic analysis data inputted in the relevant parameter, and may set hydraulic analysis demand pattern ID. In addition, the real-time operating unit (35) may draw the pump/valve operation plan and perform the hydraulic analysis calculation, be receiving water level in each tank, data relating to ON/OFF plans of the pump in history, performance data of each pump, and the electricity rate system.

In addition, the real-time operating unit (35) may draw a real-time pump/valve operation plan, a link comparison (planned value/actual performance value) result according to the real-time operation, and a node comparison (planned value/actual performance value) result according to the real-time operation by every time slot, and may store these results in the real-time operating DB (25).

Hereinafter, operation of the system according to an exemplary embodiment of the present disclosure will be described.

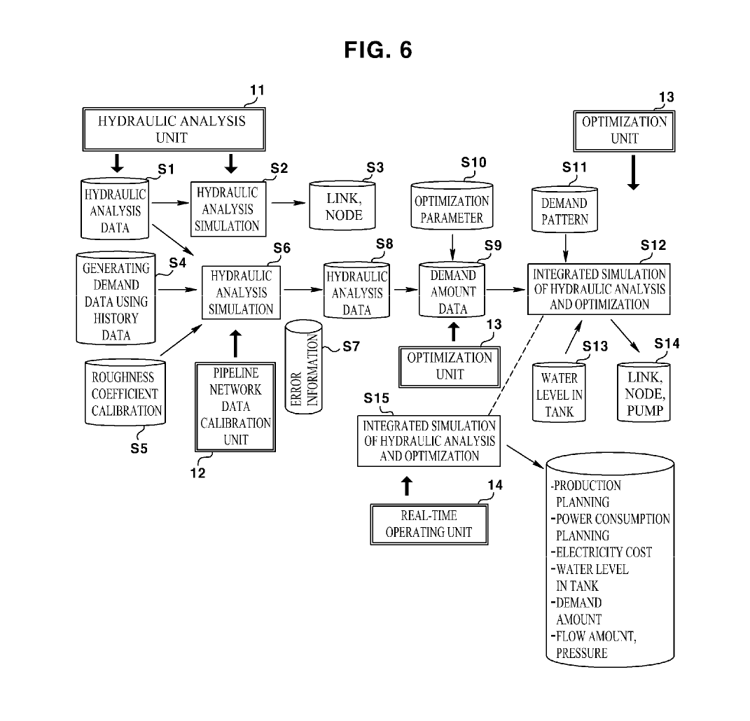

FIG. 6 is an exemplary view describing operation of the present disclosure.

As illustrated in FIG. 6, in the system according to an exemplary embodiment of the present disclosure, the hydraulic analysis unit (1) may set initial pipeline network hydraulic analysis data (S1), perform a hydraulic analysis simulation using the set initial pipeline network hydraulic analysis data (S2), and store the simulated hydraulic analysis data with respect to links and nodes forming the pipeline network (S3).

The initial pipeline network hydraulic analysis data may include pipeline network facility data and pipeline network simulation condition data. The pipeline network facility data may include a junction, a tank, a pipe, a valve and a pump. The pipeline network simulation condition data includes at least one of pattern, energy, curve, option and time.

Afterwards, in the system according to an exemplary embodiment of the present disclosure, the pipeline network calibration unit (12) may generate demand amount data using the history data (S4), and may perform a hydraulic analysis simulation(S6) by calibrating a roughness coefficient from the pump operation data (S5). In addition, the pipeline network calibration unit (12) may determine an optimal roughness coefficient based on the result of the simulation of step S6 and error information (S7) based on actual performance, and may generate hydraulic analysis data (S8). Here, the demand amount data (S4) may select a particular period through inquiry of history data of the performance forecasting DB (23), select a particular flow amount tag during the particular period, and may convert the flow amount data to the demand amount data.

In addition, the optimization unit (13) may generate demand amount data (S9), using hydraulic analysis data (S8) for optimization calculation, the optimization parameter (S10: algorithm parameter and electricity rate system), and history data. Here, the optimization unit (13) may refer the relevant hydraulic analysis tag such as water level in tank (S13) and demand pattern (S11) to a user predetermined value.

Successively, the optimization unit (13) may perform an integrated simulation of hydraulic analysis and optimization (S12) using the input data, and may output the result including a pump/valve operation plan, a power consumption plan, an electricity cost, a demand amount, a flow amount and a pressure (S14). That is, the optimization unit (13) may ascertain the input data from which the optimal pump operation schedule and the result of hydraulic analysis have been drawn, and may provide the input data as a parameter for optimization.

In the same manner as in the optimization unit (13), the real-time operating unit (14) may generate demand amount data using hydraulic analysis data (S8) for optimization calculation, the optimization parameter (S10: algorithm parameter and electricity rate system), and history data. Here, the real-time operating unit (14) may refer the relevant hydraulic analysis tag such as water level in tank and demand pattern to a real-time SCADA setting value. In addition, the real-time operating unit (14) may drive the operating server (3) by performing the integrated simulation of hydraulic analysis and optimization in real time (S15).

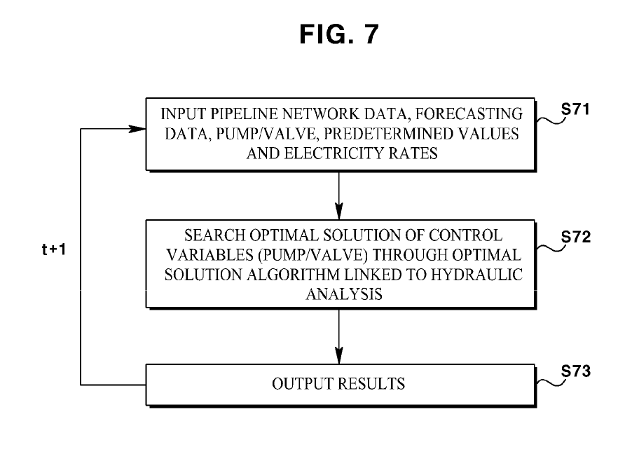

The real-time operating unit (14) may perform an integrated simulation of hydraulic analysis and optimization (S15) by every time slot, output the result including a pump/valve operation plan, a power consumption plan, an electricity cost, a demand amount, a flow amount and a pressure (S16), and display the result through the display unit (15). The operator may monitor the result on the display unit (15). The operator may draw another optimal parameter through the optimization unit (13) once again, and may reflect the optimal parameter to the real-time operating unit (14), when the result of simulation is not optimized. FIG. 7 is an exemplary view describing operation method performed by a real-time operating unit (35) of the operating server (3).

As illustrated in FIG. 7, the real-time operation unit (35) may receive hydraulic analysis result data with respect to links and nodes forming a pipeline network from the hydraulic analysis unit (11) and hydraulic analysis data for optimization calculation determined in the pipeline network data calibration unit (12), and may update the including system boundary setting value received from the SCADA unit (32). Here, the system boundary setting value may include a history and a current value of pump and valve status, and a current water level in tank.

In addition, the real-time operating unit (35) may update demand amount data by demand breakpoints received from the demand forecasting unit (34) of the operating server (3), and may receive electricity rate system set by a user from the real-time operating unit (35). In such way, the real-time operating unit (35) may receive a plural pieces of data (S71).

Successively, the real-time operating unit (35) may search an optimal solution with respect to control variables (pumps and valves) through an optimization algorithm calculation linked to hydraulic analysis (S72).

Here, the real-time operating unit (35) may search the optimal solution, so as to perform a hydraulic analysis of the pipeline network with respect to setting values of water level in pumps and tanks, and to minimize the operation cost according to the constraint conditions.

That is, an operation plan to minimize operation cost of pumps and valves may be drawn through a linkage of hydraulic analysis and optimization algorithm. As the optimization algorithm for pump and valve operation, a non-linear optimization method such as GA (Genetic Algorithm) method and search optimization method may be used. However, the above examples are intended to be illustrative, and the present disclosure is not limited hereto. In addition, as the hydraulic analysis algorithm, the EPANET developed by the United States Environmental Protection Agency may be used, but not limited hereto.

Successively, the real-time operating unit (35) may draw and output an optimal control value of a decision variable (ON/OFF of pumps and valves) determined at a current time slot. The real-time operating unit (35) may perform a hydraulic analysis simulation corresponding to the optimal control value, and may output the result data with respect to links and nodes forming the pipeline network (S73).

The optimal control value outputted in the current time slot may be used as an initial solution for the next time slot. That is, the result of step S73 may be used as an initial solution of step S71 in the next time slot.

According to an exemplary embodiment of the present disclosure, the program may be integrated through data sharing and function coupling between each application at the operator terminal and the operating server, by packaging the operating system based on hydraulic analysis and optimization algorithm.

In addition, according to an exemplary embodiment of the present disclosure, each of the applications may function independently on each other to improve expertise and efficiency of operation such as hydraulic analysis of a pipeline network and pump operating simulation, and a display may be provided for a user through the SCADA unit to enhance user convenience.

In addition, the system according to an exemplary embodiment of the present disclosure may be linked to another system, through development of application in a unit of module.

In addition, according to an exemplary embodiment of the present disclosure, various operational constraint conditions may be reflected, and the accuracy may be enhanced by linking hydraulic analysis to optimization.

Although the present disclosure has been described with reference to a number of illustrative embodiments thereof, it should be understood that numerous other modifications and embodiments can be devised by those skilled in the art that will fall within the spirit and scope of the principles of this disclosure. Therefore, the true technical scope of the rights for the present disclosure shall be decided by the claims and equivalents thereof

What is claimed is:

1. A system for managing water in a water pipe network, the system comprising:
a hydraulic analysis unit configured to output hydraulic analysis data with respect to links and nodes forming a pipeline network by performing a hydraulic analysis simulation using initial pipeline network hydraulic analysis data;
a calibration unit configured to determine an optimal roughness coefficient by comparing a result of hydraulic analysis simulation using roughness coefficient data and demand amount data of a predetermined pipeline to error information based on an actual performance, and to generate hydraulic analysis data for optimization calculation by applying the optimal roughness coefficient;
an optimization unit configured to draw an optimal pump operation schedule and a result of hydraulic analysis by performing an integrated simulation of hydraulic analysis and optimization based on the hydraulic analysis data for optimization calculation and demand amount data generated using an optimization setting parameter and history data, and to provide input data from which the optimal pump operation schedule and the result of hydraulic analysis are drawn as a parameter for optimization; and
an operator terminal including a real-time operating unit configured to draw the optimal pump operation schedule and the result of hydraulic analysis by performing an integrated simulation of hydraulic analysis and optimization based on demand amount data generated using the parameter for optimization.

2. The system of claim 1, wherein the initial pipeline network hydraulic analysis data includes pipeline network facility data and pipeline network simulation condition data.

3. The system of claim 2, wherein the pipeline network facility data includes at least one of a junction, a tank, a pipe, a valve and a pump.

4. The system of claim 2, wherein the pipeline network simulation condition data includes at least one of pattern, energy, curve, option and time.

5. The system of claim 1, wherein the calibration unit performs a hydraulic analysis simulation of roughness coefficient of the predetermined pipeline according to a plurality of cases.

6. The system of claim 1, wherein the calibration unit selects a flow amount tag during a certain period of history data, and calculates demand amount data from the flow amount data.

7. The system of claim 1, wherein the optimization unit further draws a result of demand forecasting linked to a result of the optimal pump operation schedule.

8. The system of claim 1, wherein the optimization unit further draws hydraulic analysis with respect to a link and a node corresponding to the optimal pump operation schedule.

9. The system of claim 8, wherein the optimization unit draws hydraulic analysis data with respect to a link and a node in chronological order, draws hydraulic analysis data with respect to a link and a node in an order of pipeline networks, or draws hydraulic data with respect to a link and a node in a relevant network at a predetermined time.

10. The system of claim 1, the optimization unit refers to a user predetermined value as water level in tank and demand pattern.

11. An operation method of an operating server for managing a water pipe network by receiving data from the operator terminal of the system of claim 1, the operation method comprising:
receiving hydraulic analysis data with respect to links and nodes forming a pipeline network, hydraulic analysis data for optimization calculation, and data including system boundary setting value inputted by a user;
searching an optimal solution with respect to control variables (pumps and valves) through an optimization algorithm calculation linked to hydraulic analysis; and
drawing an optimal control value of a decision variable determined at a current time slot.

12. The operation method of claim 11, wherein the system boundary setting value is received via a SCADA (Supervisory Control and Data Acquisition) unit.

13. The operation method of claim 11, wherein the data further includes demand amount data by demand breakpoints.

14. The operation method of claim 11, wherein the data further includes an electricity rate system set by a user.

15. The operation method of claim 11, further comprising:
outputting result data with respect to links and nodes forming a pipeline network by performing a hydraulic analysis simulation corresponding to the optimal control value.

16. The operation method of claim 11, wherein result data with respect to links and nodes according to the decision variable determined at a current time slot is used as hydraulic analysis data with respect to links and nodes composing a pipeline network in the step of receiving at a next time slot.
